(19) United States
(12) Patent Application Publication
(10) Pub. No.: US 2005/0003796 A1
(43) Pub. Date: Jan. 6, 2005

(54) Wireless telecommunication system, wireless base station, and wireless communication terminal

(75) Inventor: Susumu Kashiwase, Yokohama-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/806,929

(22) Filed: Mar. 23, 2004

(30) Foreign Application Priority Data
Mar. 27, 2003 (JP) PATENT 2003-87509

(51) Int. Cl. H04M 11/00

(52) U.S. Cl. 455/403; 455/450

(57) ABSTRACT

In a CDMA protocol wireless telecommunication system that allows mixed use of single carrier terminals and multiple carrier terminals, a wireless telecommunication system that can improve the utilization efficiency of the frequencies is realized. A wireless base station, single carrier terminals, multiple carrier terminals are provided, and the frequency channels are formed by a plurality of time slots, and the base station sets a preamble signal that indicates the terminal allocated to a time slot. At the same time, preamble signals for a plurality of frequency channels are transmitted nonsimultaneously. The single carrier terminal receives the preamble signals by switching the plurality of frequency channels transmitted from the wireless base station, and detects the received time slots based on the received preamble signal.

### PRIORITY CLAIM

Priority is claimed on Japanese Patent Application No. 2003-87509, filed Mar. 27, 2003, the content of which is incorporated herein by reference

### BACKGROUND OF THE INVENTION

1. Field of the Invention

The present invention relates to a code division multiple access (CDMA) protocol wireless telecommunication system, and in particular to a wireless telecommunication system that allows mixed use of a single carrier terminal and a multiple carrier terminal, and a wireless base station and wireless communication terminal for realizing this wireless telecommunication system.

2. Description of Related Art

A conventional CDMA wireless telecommunication system is known, for example, that is based on the high rate packet data (HRPD) standard specified by C. S0024, which is disclosed in 3GPP2 (http://www.3gpp2.org). This system carries out packet delivery by using time division multiple access (TDMA) protocol in a forward transmission scheme from a wireless base station (hereinbelow, referred to as a “base station”) to a wireless communication terminal (hereinbelow, referred to as a “terminal”). A single carrier terminal that carries out transmission and reception of data via one pair of frequency channels (carriers) consisting of forward transmission from a terminal to a base station and reverse transmission from a base station to a terminal is used as the terminal in this system.

In addition, the recent cdma2000 1×EV-DO protocol, which is optimized for best-effort broadband packet data, is an example of a broadband wireless telecommunication system (refer, for example, to Japanese Unexamined Patent Application, First Publication No.2002-344560). The access network in cdma2000 1×EV-DO always transmits at maximum power, except when there is no transmission data, and the data transmission from the network is carried out using TDMA (Time Division Multiple Access). Specifically, at a specific instant, data is transmitted only to one user. The data rate of the traffic channel at this time varies based on the adaptive modulation.

Moreover, as a CDMA wireless communication system that carries out packet delivery by using the CDMA protocol in a forward transmission scheme, one is known that is based, for example, on “Spread Rate 3 (SR3)” of C. S0001 and C. S0005 of the 3GPP2 standard. In this system, forward packet transmission is carried out by using a plurality of frequency channels simultaneously. Thereby, for example, transmission is carried out by using three frequency channels simultaneously with a chip rate of 1.2288 MHz. Thus, it is possible to carry out packet transmission at a transmission rate of 3.6864 MHz. A multiple carrier terminal that carries out reception of data simultaneously via a plurality of channels is used as the terminal in this system.

In addition, a CDMA wireless telecommunication system that allows mixed use of the single carrier terminal and the multiple carrier terminal described above is known. In this system, the base station uses a plurality of frequency channels for forward transmission, while the single carrier terminal receives data via one fixed frequency channel of the channels. On the other hand, the multiple carrier terminal can simultaneously receive data via a plurality of channels.

However, in the conventional system that allows mixed use of a single carrier terminal and a multiple carrier terminal described above, there is the problem that the utilization efficiency of the frequencies is low. The reason for this is that vacancies occur in a specific frequency channel due to allocation of an unreasonable number of frequency channels to a single carrier terminal, or congestion in traffic, and occupancy occurs due to a low rate of transmission.

In consideration of the problems described above, the present invention is made. The present invention, in a CDMA protocol wireless telecommunication system that allows mixed use of a single carrier terminal and a multiple carrier terminal, provides a wireless telecommunication system that can improve the utilization efficiency of the frequencies.

In addition, the present invention provides a wireless base station and a wireless communication terminal for realizing this wireless telecommunication system.

### SUMMARY OF THE INVENTION

In order to solve the problems described above, a first aspect of the present invention relates to a wireless telecommunication system. The wireless telecommunication system includes a wireless base station; at least one first wireless communication terminal that can deliver packets by using one frequency channel; and at least one second communication terminal that can deliver packets by using a plurality of frequency channels simultaneously, wherein the frequency channels are formed by a plurality of time slots; the wireless base station sets a preamble signal for indicating the terminals in the time slots to which the time slots are allocated, and transmits nonsimultaneously the preamble signal for the plurality of frequency channels; and the first wireless communication terminal receives the preamble signal by switching the plurality of frequency channels transmitted from the base station, and detects the time slot to be received based on the received preamble signal.

A second aspect of the present invention relates to a wireless base station. The wireless base station transmits information to wireless communication terminals by using a plurality of frequency channels, when the frequency channels are formed by a plurality of time slots. The wireless base station includes an information setting unit that sets a preamble signal for indicating the terminals in the time slots to which the time slots are allocated; and a transmission unit that transmits nonsimultaneously the preamble signal for the plurality of frequency channels.

A third aspect of the present invention relates to a wireless communication terminal. The wireless communication terminal can deliver packets by using one frequency channel, when the frequency channel is formed by a plurality of time slots and a preamble signal is set for indicating the terminals in the time slots to which the time slots are allocated. The wireless communication terminal includes a reception unit that receives the preamble signal by switching the plurality of frequency channels transmitted from the base station; and a detection unit that detects the time slot to be received based on the received preamble signal.

### BRIEF DESCRIPTION OF THE DRAWINGS

FIG. 1 is a block diagram showing the structure of a wireless telecommunication system according to an embodiment of the present invention.

FIG. 2 is a drawing showing an example of a channel structure according to the same embodiment.

FIG. 3 is a drawing showing an example of the TS allocation scheduling in the wireless telecommunication system shown in FIG. 1.

### DETAILED DESCRIPTION OF THE INVENTION

Below, an embodiment of the present invention will be explained with reference to the figures.

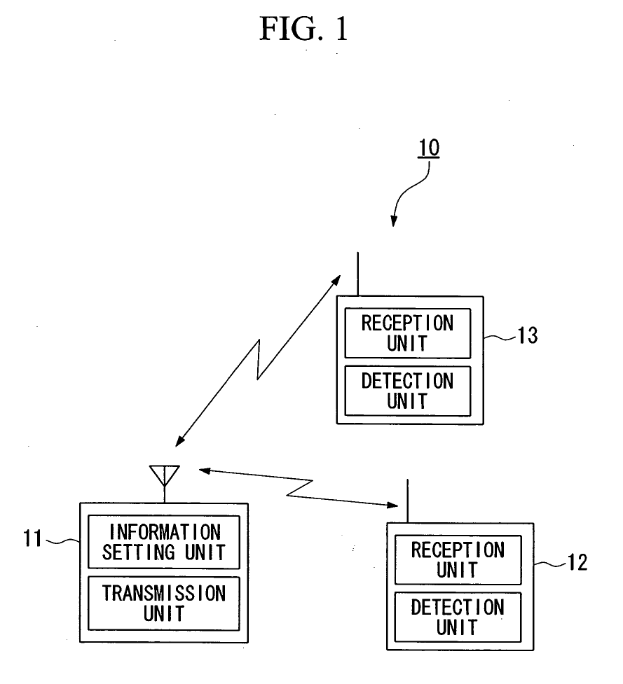

FIG. 1 is a block diagram showing the structure of a wireless telecommunication system 10 according to one embodiment of the present invention. This wireless telecommunication system 10 uses a CDMA protocol. In FIG. 1, the wireless telecommunication system 10 provides a base station 11, a single carrier terminal 12, and a multiple carrier terminal 13.

The base station 11 uses a plurality of frequency channels for forward transmission to the terminals. The single carrier terminal 12 (the first wireless communication terminal) receives data via one of these frequency channels. The multiple carrier terminal 13 (the second wireless communication terminal) can simultaneously receive data via a plurality of frequency channels.

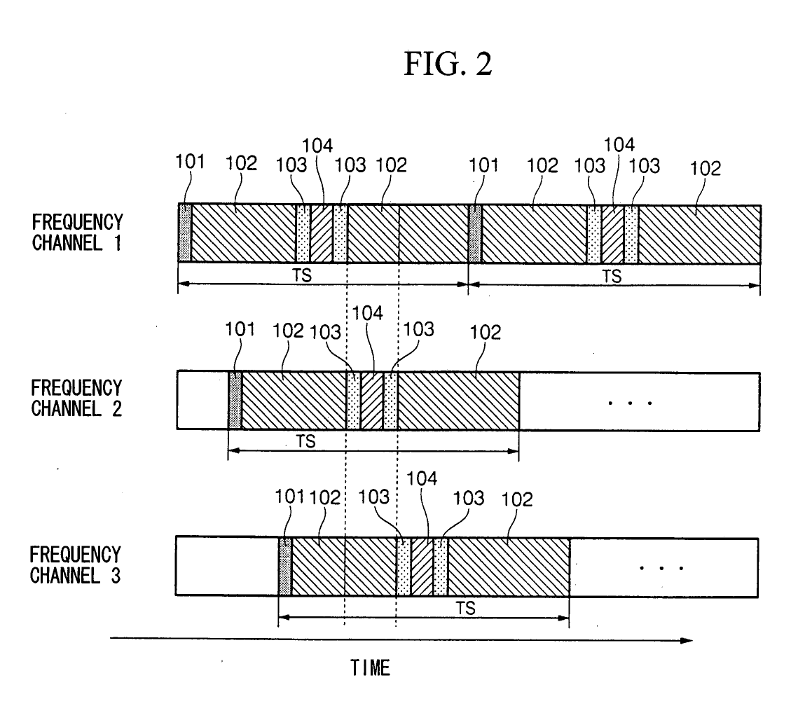

FIG. 2 is a drawing showing an example of the channel structure according to the present embodiment. In this example, three frequency channels (frequency channels 1 to 3) are used. In FIG. 2, a plurality of time slots (TSs) in each of the three frequency channels 1 to 3 are time division multiplexed. Each of the TSs consists of a preamble portion 101, a traffic channel (individual data channel) portion 102, a common control data channel portion 103, and a pilot channel portion 104. As shown in FIG. 2, the preamble portion 101 and the pilot channel portion 104 are distributed so as not to overlap temporally in any of the frequency channels 1 to 3.

The index data corresponding to each terminal is set in the preamble portion 101. Each of the terminals can determine whether or not the TS is allocated to itself from the received index data of the preamble portion 101. Specifically, the signal (preamble signal) of the preamble portion 101 functions as a signal that represents the terminal allocated to this TS.

The signal (pilot signal) for maintaining synchronism is set in the pilot channel portion 104. Each of the terminals appropriately receives the pilot signal at arbitrary intervals. The call and multiple address information is set in the common control data channel portion 103. The information in the common control data channel portion 103 is common to each of the frequency channels 1 to 3. Therefore, the information for any of the frequency channels in the common control data channel portion 103 can be received by the terminals.

The base station 11 provides an information setting unit that carries out the setting of all transmission information in FIG. 2, and a transmission unit that transmits preamble signals for the plurality of frequency channels non-simultaneously.

The single carrier terminal 12 provides a receiving unit that receives the preamble signal by switching the plurality of frequency channels transmitted from the base station 11, and a detection unit that detects the time slot that is to be received based on the received preamble signal.

Next, the operation in which each of the terminals 12 and 13 of the wireless telecommunication system 10 in FIG. 1 recognizes its own TS will be explained using the channel configuration shown in FIG. 2.

The single carrier terminal 12 obtains the index data for each of the frequency channels in the preamble portion 101 by polling while switching the received frequency channels in the order: frequency channel 1, frequency channel 2, and frequency channel 3. Then for each index data that has been obtained, the single carrier terminal 12 determines whether or not the TS is allocated to itself. As a result of this determination, in the case that the TS is allocated to the single carrier terminal 12, at this point the switching of the frequency channels is temporarily stopped and data reception in this TS is carried out. Next, after the data reception from its own time slot has completed, the switching of frequency channels is resumed, and obtaining of index data for each of the frequency channels in the preamble portion 101 is carried out.

The multiple carrier terminal 13 can carry out data reception from the three frequency channels 1 to 3 simultaneously, and thus obtains the index data for each of the frequency channels in the preamble portion 101 by polling the channels, without switching the channels, in the order: frequency channel 1, frequency channel 2, and frequency channel 3. Then for each index data that has been obtained, the multiple carrier terminal 13 determines whether or not the TS is allocated to itself, and carries out data reception any time for its own TSs for each of the frequency channels 1 to 3.

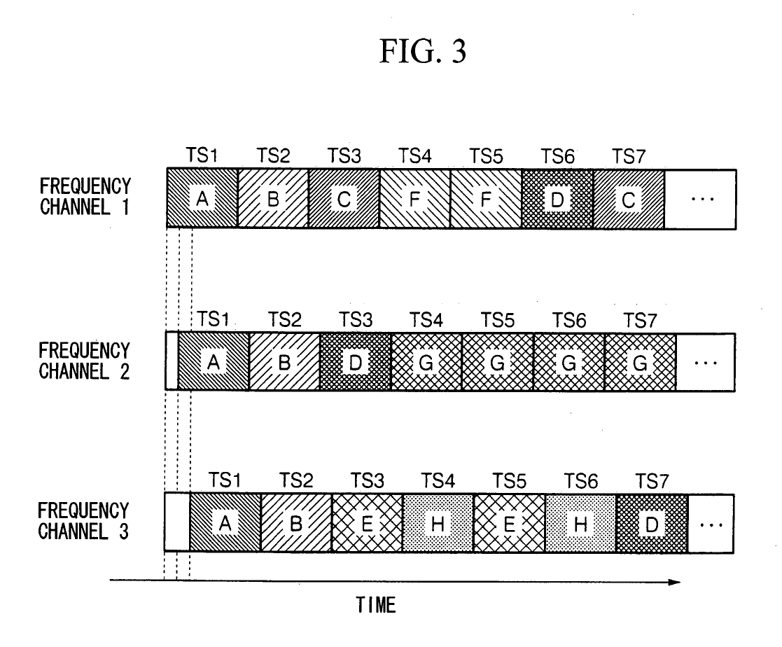

Next, the operation related to the TS allocation in the wireless telecommunication system 10 shown in FIG. 1 will be explained with reference to FIG. 3. FIG. 3 is a drawing showing an example of the TS allocation scheduling in the wireless telecommunication system 10 shown in FIG. 1. This scheduling is carried out by the base station 11.

In the example in FIG. 3, the terminals of eight users (users A to H) are accommodated by the channel configuration shown in FIG. 2 described above. Users A and B are the users of the multiple carrier terminals 13. Users C to H are the users of the single carrier terminals 12.

TSs are allocated to users A and B of the multiple carrier terminal 13 in each of the frequency channels 1 to 3 at specific cycles. In FIG. 3, TS1 is allocated to user A and TS2 is allocated to user B.

The TSs, which are not allocated to users A and B of the multiple carrier terminal 13, are allocated to users C to H of the single carrier terminals 12. In the present embodiment, for the user of a specific single carrier terminal 12, the frequency channel to be used is not static, but changes dynamically, and the TSs are allocated over a plurality of frequency channels. However, the single carrier terminal 12 can only receive one frequency channel at a time, and thus it is allocated only TSs that do not temporally overlap between frequency channels.

For example, in FIG. 3, first TS3 of frequency channel 2 is allocated to user D. Then TS4 to TS7 of frequency channel 2 are allocated to user G As a result, frequency channel 2 is occupied by the traffic of user G Thus, in frequency channel 3, TS7, which has become vacant, is allocated to user D. The TS7 of this frequency channel 3 does not temporally overlap TS3 of the frequency channel 2, which has already been allocated to user D. Thereby, the single carrier terminal 12 of user D receives the preamble signals for each of the frequency channels by switching the channels in order from frequency channel 1 to frequency channel 3, and based on the received preamble signal, first receives data of this TS3 by detecting the TS3 of frequency channel 2. Next, the data of this TS7 is received by detecting TS7 of the frequency channel 3.

According to the present embodiment described above, for a specific single carrier terminal the frequency channel to be used is not static but changes dynamically, and thus it is possible to allocate a vacant TS without limitation by the frequency channels to an appropriate and suitable single carrier terminal. In addition, by allocating each of the single carrier terminals to respective frequency channels, the effect of making possible an increase in allocation of channel resources to multiple carrier terminals is obtained.

In addition, in the case that the transmission condition of the single carrier terminal using a certain frequency channel deteriorates, another frequency channel can be used, and thereby it becomes possible to prevent a lowering of the transmission speed of this single carrier terminal, and it is possible to prevent lowering of the sector throughput. In addition, because it is possible to prevent the concentration of single carrier terminals only in a certain frequency channel, similarly, a lowering of the sector throughput can be prevented.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

As explained above, according to the present invention, the used frequency channels are not static but dynamically changed for a specific first wireless communication terminal (single carrier terminal), and thus it becomes possible to improve the utilization efficiency of frequencies in a CDMA protocol wireless telecommunication system that allows mixed use of single carrier terminals (first wireless communication terminals) and multiple carrier terminals (second wireless communication terminals).

1. A wireless telecommunication system comprising:
a wireless base station;
at least one first wireless communication terminal that delivers packets by using one frequency channel; and
at least one second wireless communication terminal that delivers packets by using a plurality of frequency channels simultaneously,
wherein the frequency channels are formed by a plurality of time slots;
the wireless base station sets a preamble signal in the time slots for indicating one of the terminals to which the time slots are allocated, and transmits nonsimultaneously the preamble signal for the plurality of frequency channels; and
the first wireless communication terminal receives the preamble signal by switching the plurality of frequency channels transmitted from the base station, and detects the time slot to be received based on the received preamble signal.

2. A wireless base station that transmits information to wireless communication terminals by using a plurality of frequency channels, the frequency channels being formed by a plurality of time slots, the wireless base station comprising:
an information setting unit that sets a preamble signal in the time slots for indicating the terminals to which the time slots are allocated; and
a transmission unit that transmits nonsimultaneously the preamble signal for the plurality of frequency channels.

3. A wireless communication terminal that can deliver packets by using one frequency channel, the frequency channel being formed by a plurality of time slots, a preamble signal in the time slots being set for indicating the terminals to which the time slots are allocated, the wireless communication terminal comprising:
a reception unit that receives the preamble signal by switching the plurality of frequency channels transmitted from the base station; and
a detection unit that detects the time slot to be received based on the received preamble signal.
